(19) United States
(12) Patent Application Publication
(10) Pub. No.: US 2013/0011565 A1
(43) Pub. Date: Jan. 10, 2013

(54) TREATMENT SOLUTION FOR FORMING OXIDATION-RESISTANT FILM ON SURFACE-COATED CERMET

(75) Inventor: Kimihisa Hiramoto, Oyama-shi (JP)

(73) Assignee: SHOWA DENKO K.K., Minato-ku, Tokyo (JP)

(21) Appl. No.: 13/577,101

(22) PCT Filed: Feb. 1, 2011
(86) PCT No.: PCT/JP2011/052043

§ 371 Date: Sep. 28, 2012

(30) Foreign Application Priority Data
Feb. 3, 2010 (JP) 2010-022043

(51) Int. Cl. C09D 5/08; B05D 5/00; C08K 5/053

(52) U.S. Cl. 427/299; 106/14.05; 106/14.21; 106/14.14; 106/14.44; 427/372.2

(57) ABSTRACT

A processing solution for forming an oxidation resistant film on a surface-coated cermet member is provided, wherein the processing solution is capable of easily forming an oxidation resistant film improving the oxidation resistance while maintaining the excellent performance of a titanium sintered body. The composition of the processing solution of the present invention includes a metal salt which creates a complex oxide by reacting with a titanium compound and 20 mass % or more of a solvent. It is preferable that the metal salt is a transition metal of divalent iron ion. An oxidation resistant film 12 containing a complex oxide can be formed by heating the processing solution of the present invention after applying it to a cermet base material 11.

### TECHNICAL FIELD

The present invention relates to a processing solution for forming an oxidation resistant film on a cermet base material constituted by a titanium series sintered body.

### BACKGROUND TECHNIQUE

A titanium carbonitride series sintered body (titanium carbonitride base cermet) having titanium carbonitride (TiCN) as a main component of a hard phase and iron group metal as a main component of a bonded phase has excellent characteristics, such as, e.g., being high in hardness and strength, as well as being hard to react with aluminum and its alloy, high in slide characteristic with respect to various metals, and capable of obtaining a low coefficient of friction. For such reasons, a titanium carbonitride series sintered body is suitably used for a metal processing product, such as, e.g., a tube diameter expansion die, a tube diameter reduction die, or a cutting chip for a metal pipe.

However, when such TiCN series cermet is exposed to an atmosphere containing oxygen at a high temperature, titanium which is a structural element thereof is oxidized to create titanium oxide on the cermet surface. Since the titanium oxide is brittle, when metal is processed with a cermet tool having a titanium oxide film, the titanium oxide film falls off, causing a rough surface, which in turn deteriorates the machining performance. Furthermore, the titanium oxide layer is abraded quickly, which deteriorates the durability.

Under the circumstances, in order to improve the oxidation resistance of titanium series cermet, it has been proposed to add other elements to the component constituting the cermet.

For example, in the case of the cermet disclosed by Patent Document 1, chromium is added to the titanium series sintered material, so that the cermet is constituted by a complex compound of chromium (Cr) and titanium (Ti) as a main component to improve the oxidation resistance.

On the other hand, although the purpose is not to improve oxidation resistance, conventionally, many surface-coated cermet materials in which a hard film is formed on a titanium series sintered body have been proposed.

For example, in the case of the surface-coated cermet member disclosed by Patent Document 2, a hard film containing titanium is formed on the surface of the cermet as a base material by means of, e.g., a CVD (chemical vapor deposition method) and a PVD (physical vapor deposition method).

Furthermore, in the case of the surface-coated cermet material disclosed by Patent Document 3, a hard film is formed on a surface of a cermet base material and a diffusing element contained layer is formed at the boundary between the surface of the cermet base material and the hard film to improve adhesion of the hard film.

### PRIOR ART

### Patent Document

Patent Document 1: Japanese Unexamined Laid-open Patent Application Publication No. 2006-213977 (see claims)
Patent Document 2: Japanese Unexamined Laid-open Patent Application Publication No. 2005-111623 (see claims)
Patent Document 3: Japanese Unexamined Laid-open Patent Application Publication No. 2000-355777 (see claims)

### SUMMARY OF THE INVENTION

### Problems to be Solved by the Invention

However, in the cermet (sintered body/compact) in which other components are added to components of a titanium series sintered material as disclosed by Patent Document 1, the cermet is different in component from a titanium series sintered body, and changes in quality, which causes a problem that the excellent performance of the titanium series sintered body is deteriorated.

In the surface-coated cermet material disclosed by Patent Document 2, a hard film is simply formed by diffusion. The cermet member, however, differs in the amount of diffusion between the bonded phase (Co) and the hard phase (TiC) of the cermet base material. For this reason, for example, the diffusion hardly progresses on the hard phase, causing a problem that adhesion of the hard film deteriorates, which makes it difficult to maintain sufficient oxidation resistance due to detachment.

In the surface-coated cermet material disclosed by Patent Document 3, a diffusing element contained layer is further formed at the boundary between the hard film and the cermet base material, which causes a problem that the structure becomes complicated, resulting in difficult production.

The preferred embodiments of the present invention have been developed in view of the above-mentioned and/or other problems in the related art. The preferred embodiments of the present invention can significantly improve upon existing methods and/or apparatuses.

The present invention was made in view of the aforementioned problems, and aims to provide a processing solution for forming an oxidation resistant film on a surface-coated cermet, which is capable of easily forming the oxidation resistant film that can improve oxidation resistance, while keeping the excellent performance of titanium series sintered body.

Other objects and advantages of the present invention will be apparent from the following preferred embodiments.

### Means for Solving the Problems

In order to attain the aforementioned objects, the present invention has the structure summarized below.

[1] A processing solution for forming an oxidation resistant film on a surface-coated cermet material, wherein the processing solution contains a metal salt which creates a complex oxide by reacting with a titanium compound, and 20 mass % or more of a solvent.

[2] The processing solution for forming an oxidation resistant film on a surface-coated cermet material as recited in the aforementioned Item 1, wherein the processing solution is used for forming an oxidation resistant film containing a complex oxide by applying the processing solution onto a cermet base material and heating it to react with a titanium compound on a surface of the cermet base material.

[3] The processing solution for forming an oxidation resistant film on a surface-coated cermet material as recited in the aforementioned Item 2, wherein the cermet base material is constituted by a sintered body including at least one or more titanium compounds selected from the group consisting of titanium carbide, titanium nitride, and titanium carbonitride as a main component of a hard phase.

[4] The processing solution for forming an oxidation resistant film on a surface-coated cermet material as recited in any one of the aforementioned Items 1 to 3, wherein the metal salt is a compound of transition metal of divalent iron ion.

[5] The processing solution for forming an oxidation resistant film on a surface-coated cermet material as recited in the aforementioned Item 4, wherein the transition metal is Fe, Ni, Co, Mn, Mg, or Zn.

[6] The processing solution for forming an oxidation resistant film on a surface-coated cermet material as recited in the aforementioned Item 4, wherein the compound of transition metal is nickel acetate.

[7] The processing solution for forming an oxidation resistant film on a surface-coated cermet material as recited in any one of the aforementioned Items 1 to 3, wherein the metal salt is an alkaline-earth metal compound.

[8] The processing solution for forming an oxidation resistant film on a surface-coated cermet material as recited in the aforementioned Item 7, wherein the alkaline-earth metal is Ca, Sr, or Ba.

[9] The processing solution for forming an oxidation resistant film on a surface-coated cermet material as recited in the aforementioned Item 7, wherein the alkaline-earth metal compound is calcium acetate.

[10] The processing solution for forming an oxidation resistant film on a surface-coated cermet material as recited in any one of the aforementioned Items 1 to 3, wherein the metal salt is magnesium salt or cobalt salt.

[11] The processing solution for forming an oxidation resistant film on a surface-coated cermet material as recited in any one of the aforementioned Items 1 to 3, wherein the metal salt is cobalt acetate.

[12] The processing solution for forming an oxidation resistant film on a surface-coated cermet material as recited in any one of the aforementioned Items 1 to 11, wherein the processing solution further contains a surfactant.

[13] The processing solution for forming an oxidation resistant film on a surface-coated cermet material as recited in any one of the aforementioned Items 1 to 12, wherein the solution contains water and a water soluble thickener.

[14] The processing solution for forming an oxidation resistant film on a surface-coated cermet material as recited in any one of the aforementioned Items 1 to 13, wherein the solution contains water and a water-soluble polyalcohol.

[15] The processing solution for forming an oxidation resistant film on a surface-coated cermet material as recited in any one of the aforementioned Items 1 to 14, wherein the solution further contains an organic acid.

[16] The processing solution for forming an oxidation resistant film on a surface-coated cermet material as recited in any one of the aforementioned Items 1 to 15, wherein the solution further contains a sodium salt.

[17] A method of producing a surface-coated cermet material, comprising:

a process of applying the processing solution as recited in any one of the aforementioned Items 1 to 16 on a surface of a cermet base material constituted by a sintered body including at least one or more titanium compounds selected from the group consisting of titanium carbide, titanium nitride, and titanium carbonitride as a main component of a hard phase; and

a process of forming an oxidation resistant film by heating the processing solution applied surface-coated cermet material after applying the processing solution.

[18] A method of producing a surface-coated cermet material, comprising:

a process of oxidizing a cermet base material constituted by a sintered body including at least one or more titanium compounds selected from the group consisting of titanium carbide, titanium nitride, and titanium carbonitride as a main component of a hard phase;

a process of applying a processing solution as recited in any one of the aforementioned Items 1 to 16 on a surface of the oxidized cermet base material; and

a process of forming an oxidation resistant film by heating the processing solution applied surface-coated cermet material after applying the processing solution.

### Effects of the Invention

According to the inventions [1] and [2], the processing solution contains a metal salt which creates a complex oxide by reacting with a titanium compound. Therefore, when the processing solution is heated after applying it to the cermet base material, for example, an oxidation resistant film containing a complex oxide can be formed on a surface of the cermet base material, which improves the oxidation resistance of the cermet material.

According to the invention [3], an oxidation resistant film capable of improving the oxidation resistance while maintaining the excellent performance of a titanium series sintered body can be easily formed.

According to the invention [4], since the metal salt is a compound of transition metal of divalent iron ion, the oxidation resistance of the oxidation resistant film can be improved.

According to the invention [5], the oxidation resistance of the oxidation resistant film can be further improved since the transition metal is Fe, Ni, Co, Mn, Mg, or Zn.

According to the invention [6], the oxidation resistance of the oxidation resistant film can be further improved since the transition metal compound is nickel acetate.

According to invention [7], the oxidation resistance of the oxidation resistant film can be improved since the metal salt is an alkaline-earth metal compound.

According to the invention [8], the oxidation resistance of the oxidation resistant film can be further improved since the alkaline-earth metal is Ca, Sr or Ba.

According to the invention [9], the oxidation resistance of the oxidation resistant film can be further improved since the alkaline-earth metal compound is calcium acetate.

According to the invention [10], the oxidation resistance of the oxidation resistant film can be further improved since the metal salt is magnesium salt or cobalt salt.

According to the invention [11], the oxidation resistance of the oxidation resistant film can be further improved since the metal salt is cobalt acetate.

According to the invention [12], the wettability of the processing solution to the cermet base material surface can be improved because the processing solution contains a surfactant, which enables formation of an excellent oxidation resistant film.

According to the invention [13], since the processing solution contains water as a solvent and a water-soluble thickener, an appropriate viscosity can be obtained, which prevents occurrence of “flowing down” of the applied processing solution.

According to the invention [14], since the processing solution contains water as a solvent and a water-soluble polyalcohol, the oxidation resistant film can be sufficiently prevented from being exfoliated due to, e.g., shrinkage.

According to the invention [15], since the processing solution contains an organic acid, precipitation of metal salt in the processing solution can be prevented, which enables to provide a stable processing solution.

According to the invention [16], since the processing solution contains a sodium salt, a forming temperature of a complex oxide can be kept low. In other words, a complex oxide can be formed by heating at a low temperature.

According to the inventions [17] and [18], a surface-coated cermet material in which the oxidation resistance is improved while maintaining the excellent performance of titanium series sintered body can be produced.

### BRIEF EXPLANATION OF THE DRAWINGS

FIG. 1 is a cross-sectional view schematically showing a surface-coated cermet material to be produced by the production method of the present invention.

FIG. 2 is a block diagram showing an example of a production process of the surface-coated cermet material.

FIG. 3 is a block diagram showing another example of a production process of the surface-coated cermet material.

FIG. 4 is a cross-sectional view schematically showing a periphery of an extrusion die portion of an extruder applied to an embodiment of the present invention.

FIG. 5 is a graph showing changes of thermogravimetry of a sample of the present invention and a sample of a comparative example.

### EMBODIMENTS FOR CARRYING OUT THE INVENTION

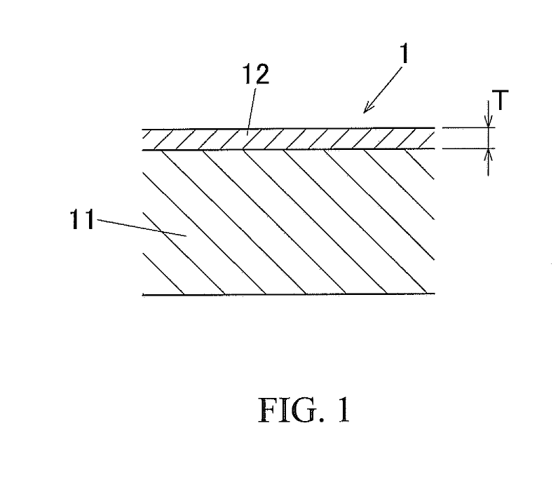

FIG. 1 is a cross-sectional view schematically showing a titanium series surface-coated cermet material 1 used in an embodiment of the present invention. As shown in this figure, this surface-coated cermet material 1 is provided with a cermet base material 11 and an oxidation resistant film 12 formed on the cermet base material 11.

In this embodiment, the cermet base material 11 is constituted by a sintered body of titanium carbonitride (TiCN). This TiCN series sintered body (TiCN series cermet) is constituted by a complex material including a hard phase including titanium carbonitride as a main component (a component whose content rate in the hard phase is 50 mass % or more) and a bonded phase including iron metal, such as, e.g., nickel (Ni) or cobalt (Co) as a main component (a component whose content rate in the bonded phase is 50 mass % or more).

In the present invention, the main component of the hard phase in the cermet base material 11 is not limited to titanium carbonitride, and can be at least one or more titanium compounds among titanium carbide, titanium nitride, and titanium cardonitride. For example, as the main component of the hard phase of the cermet base material 11, a multicomponent system titanium compound, such as, e.g., TiCN—WC—TaC, TiC-WC—TaC, can be used.

Furthermore, the cermet base material is not always limited to a material constituted only by cermet. For example, the cermet base material can be constituted such that a cermet layer is formed on a surface of a material other than cermet, such as, e.g., dies steel or ceramics. Further, the method of forming a cermet layer on a surface of a material other than cermet, such as, e.g., dies steel or ceramics, is not specifically limited, and can preferably be, for example, a thermal spraying method or a PVD method.

The oxidation resistant film 12 is constituted by a complex oxide containing titanium. It is preferable that the complex oxide containing titanium has an oxygen ion close-packed crystal structure. In cases where the complex oxide has an oxygen ion close-packed crystal structure, it has a stable structure in which oxygen ion is hard to move, which enables formation of an oxidation resistant film (passive film) excellent in oxidation resistance.

As the complex oxide, for example, perovskite (CaTiO₃)-type complex oxide, ilmenite (FeTiO₃)-type complex oxide, and spinel (MgAl₂O₄)-type complex oxide can be exemplified as preferable examples.

Among them, perovskite-type complex oxide and ilmenite-type complex oxide are extremely high in symmetry and stability in a crystal structure, which can more assuredly prevent movements of oxygen ion. This in turn can form an oxidation resistant film further enhanced in oxidation resistance.

As such perovskite-type complex oxide, an oxide having a chemical composition of, e.g., CaTiO₃, SrTiO₃, or BaTiO₃, can be exemplified.

This perovskite-type complex oxide has, in a structure in which oxygen ions are face-centered cubic type close-packed, a structure in which a positive ion having a large ion radius, such as, Ca²⁺, Sr²⁺_{f} or Ba²⁺, is substituted by an oxygen ion at a position of 12-coordinate, and a Ti⁴⁺ ion having a small ion radius is entered into the gap between the oxygen ion and the positive ion. In other words, it has a structure in which a small Ti⁴⁺ ion is entered into the gap between the close-packed large divalent positive ion and oxygen ion. This crystal structure is very stable, and as mentioned before, and has a structure in which oxygen ions are hard to move.

The oxidation resistant film 12 of perovskite-type complex oxide is formed by reacting alkaline-earth metal, such as, e.g., Ca, Sr, and Ba, with titanium oxide, such as, e.g., titanium oxide (TiO₂) formed on a surface of the cermet base material.

As the ilmenite-type complex oxide, an oxide having a chemical composition of, e.g., FeTiO₂, NiTiO₂, CoTiO₃, MnTiO₃, MgTiO₃, or ZnTiO₂, can be exemplified.

This ilmenite-type complex oxide has the same crystal structure as that of corundum, and has, in an oxygen ion hexagonal close-packed structure, a structure in which cations are arranged at (six-coordinate) positions of oxygen ion gaps. In other words, it has a structure in which Fe²⁺, Ni²⁺, CO²⁺, Mn²⁺, Mg²⁺, Zn²⁺ ions having a small ion radius and Ti⁴⁺ ions are arranged in gaps of the close-packed oxygen ions. This crystal structure is also extremely stable, and, as explained above, has a structure in which oxygen ions are hard to move.

The oxidation resistant film 12 of ilmenite-type complex oxide is formed by reacting iron group divalent ion transition metal, such as, e.g., Fe, Ni, Co, Mn, Mg, or Zn, with titanium oxide formed on a surface of the cermet base material.

As the spinel-type complex oxide, an oxide having a chemical composition of, e.g., MgTi₂O₄, Mg₂TiO₄, CoTi₂O₄, or Co₂TiO₄, can be exemplified.

This spinel-type complex oxide has a structure in which oxygen ions are closely packed into a face-oriented cubic shape. Spinel-type complex oxide including Ti is a crystal different in electric charge of Ti ion and slightly less in stability. However, Ti³⁺ ion is not actually observed, and although it is complex oxide of the same element, it is considered that this spinel-type complex oxide has a Mg₂TiO₄ spinel-type structure having tetrad Ti rather than triad MgTi₂O₄, or a structure in which Mg is arranged in the so-called A-site and Mg and Ti⁴⁺ are arranged in the B site.

On the other hand, in the present invention, titanium oxide of, e.g., anatase-type, rutile-type, Brookite-type formed on the cermet base material 11 will not be used as an oxidation resistant film 12. In other words, in these titanium oxides, oxygen ions are not closely-packed, and therefore the structure is brittle due to the non-compact structure. For this reason, in an aerobic environment of a high temperature of, e.g., 450° C. or above, a titanium oxide layer grows thick as time passes, and numerous cracks and/or holes are formed in the layer, making it difficult to obtain sufficient oxidation resistance.

Although rutile-type titanium oxide is relatively high in symmetry property among titanium oxides, it has a TiO₆ regular octahedron crystal structure with a distorted center and lacks stability. Therefore, the structure includes many gaps, which causes easy movements of oxygen ions, and therefore it is hard to prevent oxidation.

In this embodiment, it is preferable that the thickness T of the oxidation resistant film 12 to be formed on the cermet base material 11 is adjusted to 0.5 μm or less, preferably 0.4 μm or less, and more preferably 0.1 μm or more. In other words, if the film thickness T is too large, as it will be explained later, the exfoliated surface of the oxidation resistant film 12 exfoliated from the extrusion die constituted by the surface-coated cermet material 1 according to the present invention might become rough. On the other hand, if the film thickness T is too thin, it might be difficult to obtain sufficient oxidation prevention effect.

Next, a process for forming the aforementioned oxidation resistant film 12 on the cermet base material 11 will be explained.

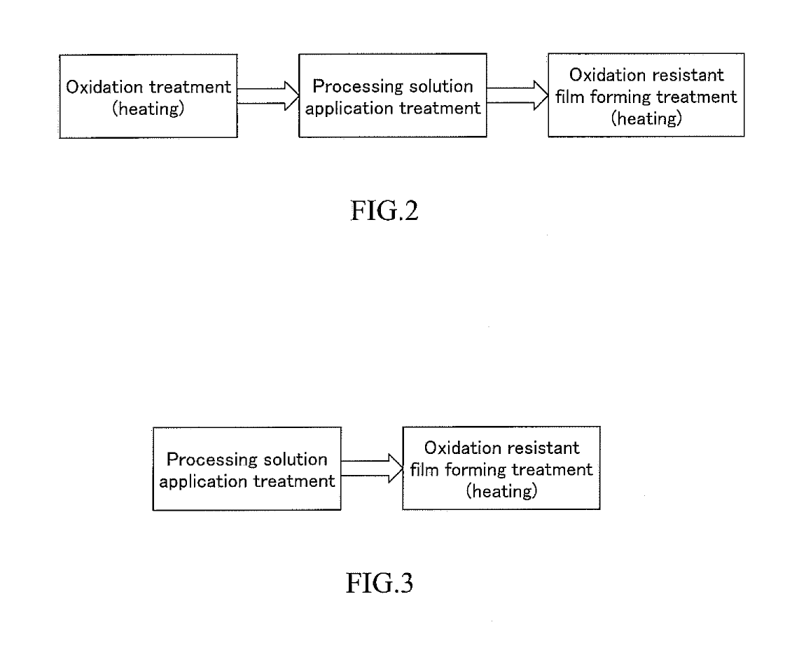

As shown in FIG. 2, initially, the cermet base material 11 is heated to perform oxidation treatment, and then a processing solution containing a predetermined metal salt is applied on the surface of the cermet base material 11 (processing solution application treatment). Thereafter, the cermet base material 11 is dried and then heated to have the metal salt in the processing solution react with the titanium oxide (oxide titanium) on the surface of the cermet base material to form complex oxide as an oxidation resistant film 12.

In this embodiment, the metal salt which reacts with a titanium oxide to form a perovskite-type complex oxide is earth alkaline metal, such as, e.g., Ca, Sr and Ba, and the earth alkaline metal compound is contained in the processing solution. As the earth alkaline metal compound, for example, calcium acetate (such as calcium acetate 1 hydrate) can be exemplified.

The metal salt which forms an ilmenite-type complex oxide is iron group divalent ion transition metal, such as, e.g., Fe, Ni, Co, Mn, Mg, and Zn, and the transition metal compound is contained in the processing solution. As a compound of the transition metal, for example, nickel acetate (nickel acetate (II), 4 hydrate) can be exemplified.

The metal salt which forms a spinel-type complex oxide is salt of Mg or Co, and these metal compounds are contained in the processing solution. As the metal compound, for example, cobalt acetate (cobalt acetate (II), 4 hydrate) can be exemplified.

On the other hand, for the processing solution containing metal salt, aqueous or non-aqueous solvent is used depending on various additives to be added.

The amount of solvent contained in the processing solution needs to be set 20 mass % or more, and it is preferably set 95 mass % or less and more preferably 50 mass % or more and 80 mass % or less. When the amount of solvent contained is adjusted within the specified range, a high quality oxidation resistant film 12 can be formed. That is, when the amount of solvent contained deviates from the above-specified range, as explained later, the processing solution cannot be supplied with appropriate viscosity so it becomes difficult to form an even oxidation resistant film 12, and the quality of the oxidation resistant film 12 may be decreased.

Furthermore, the film forming processing solution has a problem of “wettability” with respect to the surface of the cermet base material 11. If the “wettability” is poor, at the time of applying the processing solution onto the surface of the cermet base material, the processing solution is repelled by the surface of the cermet base material, which may make it difficult to form a desired oxidation resistant film 12 due to the insufficient application amount. Therefore, when the “wettability” is poor, the problem must be solved. In order to solve the problem, it can be preferable to employ a method in which an extremely thin oxide layer is formed on the surface of the base material by oxidizing the surface of the cermet base material 11 with oxygenated water or by oxidizing the surface of the cermet base material 11 by heating it in air. Further, the “wettability” can be improved by adding appropriate additives such as surfactant to the processing solution.

At the time of applying a processing solution onto the cermet base material 11, there arises a problem of “flowing down” of the processing solution depending on the viscosity of the processing solution. If the “flowing down” occurs, it becomes difficult to form a desired oxidation resistant film 12 because of insufficient processing solution. Since there always exists a protrusion especially in a three-dimensional shape, the “flowing down” easily occurs at the protrusion. For this reason, in the case of a processing solution using an aqueous solution, in order to solve the problem of “flowing down,” it is recommended to perform steps subsequent to drying treatment and heating treatment in a state in which occurrence of “flowing down” is assuredly prevented by adding aqueous paste (thickening agent) to the processing solution to give proper viscosity.

Depending on the type and/or density of the paste, the coated film after drying out the moisture may sometimes be exfoliated due to, e.g., contraction. This contraction-exfoliation problem can be solved by adding aqueous polyalcohol having a relatively high boiling point as a plasticizer. By adding it, the film can maintain elasticity even after drying out the moisture.

If the solubility of the metal salt in the processing solution is low, precipitation of the metal salt may sometimes occur. This solubility problem can be solved by adding organic acid, such as, e.g., formic acid, acetic acid, and citric acid to the processing solution.

Also, if it is necessary to lower the temperature of formation of complex oxides (for example, if it is necessary to lower to 500° C. or below), sodium salt (for example, sodium hydrogen carbonate) which produces complex oxides at a low temperature can be added as reaction auxiliary agent.

As mentioned above, an aqueous processing solution contains, for example, paste, surface acting agent, plasticizer, organic acid and reaction auxiliary agent in addition to metal salt and solvent, and is constituted by, e.g., slurry or paste having viscosity.

As a method for applying the processing solution onto the surface of the cermet base material 11, for example, a method of applying the processing solution with a brush, a method of spraying the processing solution with a spray, and a method of immerging the cermet base material 11 into the processing solution can be employed.

In this embodiment, the oxidation resistant film 12 is formed by heating the cermet base material 11 after drying the processing solution applied on the cermet base material 11. The heating condition at the time of the film formation is, when sodium is not added, preferably set to 1 to 60 minutes at 380 to 700° C., more preferably 2 to 20 minutes at 570 to 620° C. In other words, if the heating temperature is too high, there is a risk that the progress of oxidation is faster than the formation of the oxidation resistant film 12, and if the heating temperature is too low or the heating time is too short, the formation of the oxidation resistant film 12 becomes insufficient or the oxidation resistant effect cannot be sufficiently obtained because the film thickness is too thin.

In the aforementioned example, oxidation treatment by heating is conducted prior to application of the processing solution to the cermet base material 11. Although it is preferable to facilitate the oxidation of titanium by heating before applying the processing solution, the heating oxidation treatment is not always necessary, and can be omitted. In other words, as shown in FIG. 3, it can be configured such that the processing solution is applied to the cermet base material 11 (processing solution application treatment) without performing heating oxidation treatment and then dried, and the oxidation resistant film formation treatment by heating is performed. In this way, even if oxidation treatment is not performed beforehand, a titanium oxide film is formed on the surface of the cermet base material 11 to some extent at the time of the oxidation resistant film formation, so the desired oxidation resistant film 12 can be formed by the reaction of titanium oxide and processing solution.

As it is obvious, even in the case of forming an oxidation resistant film 12 of any of perovskite-type complex oxide, ilmenite-type complex oxide and spinel-type complex oxide, the oxidation treatment before applying the processing solution can be omitted.

In this way, an oxidation resistant film 12 is formed on the surface of the titanium carbonitride series cermet base material 11, and the TiCN-type surface-coated cermet member 1 according to the present invention is produced. In the surface-coated cermet member 1, the component of the cermet base material 11 is the same as the component of the TiCN-type sintered body, and the property of the base material 11 will not change, and therefore the excellent performance of the TiCN-type sintered body can be assuredly obtained.

Furthermore, the surface-coated cermet member 1 according to the present invention can be easily manufactured by simply applying the processing solution onto the cermet base material 11 and heating it.

In particular, since the oxidation resistant film 12 is formed by reacting the metal salt in the processing solution with the titanium oxide film to be formed on the cermet base material 11, the oxidation resistant film 12 can be assuredly formed without being influenced by the type, etc., of the element contained in the cermet base material, resulting in easy formation of the oxidation resistant film 12, which in turn can more easily produce the surface-coated cermet member 1.

As will be apparent from the following embodiments, the surface-coated cermet member 1 according to the present invention can enhance the oxidation resistance, especially the oxidation resistance under high temperature environment.

In the embodiment, the aforementioned surface-coated cermet member 1 is employed as an extrusion die. In the present invention, the entirety of the extrusion die can be constituted by the surface-coated cermet member 1, but in this embodiment, only a part (main portion) of the extrusion die is constituted by the surface-coated cermet member 1.

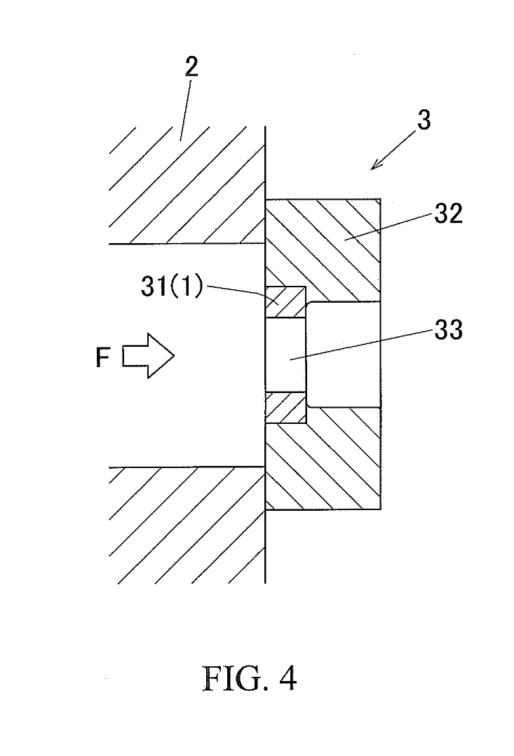

Specifically, the extrusion die 3 of the extruder shown in FIG. 4 is provided with a die main body 31 such as a bearing portion, and a die holder 32 supporting the die main body 31. The die main body 31 of the extrusion die 3 is constituted by the surface-coated cermet base material 1 and the die holder 32 is constituted by steel material, etc. In manufacturing the extrusion die 3 of this structure, for example, the cermet base material 11 as a die main body 31 is thermally inserted into the heated die holder 32, and then an oxidation resistant film 12 is formed on the cermet base material 11 as mentioned above so that the die main body 31 is constituted by the surface-coated cermet member 1.

If the temperature at the time of forming the oxidation resistant film 12 exceeds the tempering temperature of the steel material, the hardness of the die holder 32 decreases. Therefore, the film forming temperature should be set to the tempering temperature of the steel material or below thereof. In the case of an SKD 61 hot work die steel material, complex oxide is preferably formed at 520° C. or below. This condition can be met by adjusting the temperature to around 500° C. and the heating time is set to around 30 minutes at the time of forming the film, which allows formation of the oxidation resistant film 12 having a film thickness of 0.2 μm. The heating temperature at the time of forming the film is relatively low as compared with the temperature for forming a general oxidation film, and the adhesiveness of the oxidation resistant film 12 with respect to the cermet base material 11 is not so high. As will be mentioned later, however, in this embodiment, it is required to remove (exfoliate) the oxidation resistant film 12 promptly from the cermet base material 11 after the initiation of the extrusion processing, and therefore even if the adhesiveness of the oxidation resistant film 12 is not high, no inconvenience occurs, and it meets the condition in which the oxidation resistant film 12 is promptly removed at a desired time.

Next, an extrusion process using the extrusion die 3 having the aforementioned structure will be explained. Before actually performing the extrusion, the extrusion die 3 is preheated in a preheating furnace. At the time of preheating, the extrusion die 3 is exposed to the oxygen atmosphere under a high temperature, but because the die main body 31 of the extrusion die 3 is constituted by the surface-coated cermet member 1, oxidation of the cermet base material 11 is prevented by the oxidation resistant film 12, which prevents formation of titanium oxide. Therefore, emboritllement of the surface due to formation of titanium oxide can be prevented, effectively preventing falling off at the time of extrusion performed later, which can improve the corrosion resistance and durability. The preheating conditions are the same as those of a second embodiment which will be explained later.

After completion of the preliminary heating, the extrusion die 3 is set to the container 2 of the extruder and extrusion processing is initiated. At the time of this extrusion processing, the extrusion material (metal material F) in the container 2 is moved toward the extrusion die 3 in a pressurized state and passes through the extrusion hole 33 of the extrusion die 3 to thereby form an extruded product. On the other hand, when the extrusion processing is initiated, the oxidation resistant film 12 of the surface-coated cermet member 1 constituting the die main body 31 is scraped away by the extrusion member F flowing in a pressurized state. Thus, the oxidation resistant film 12 is quickly removed (exfoliated). With this, the die main body 31 is constituted by a bared cermet base material 11 having no film. As a result, the die main body 31 can fully exert the excellent performance (excellent performance such as hard to react with aluminum or its alloy) of the TiCN series sintered body (cermet base material). For this reason, for example, dimensional stability, strength, and hardness of the die main body 31 can be sufficiently obtained, resulting in a stable and smooth extrusion with high dimensional accuracy. This makes it possible to obtain an extruded product with high quality in terms of surface state and dimensional accuracy and also makes it possible to prevent early deterioration, breakage, and dropping, which in turn can assuredly improve the deterioration resistance, corrosion resistance, and durability. Further, by using the TiCN sintered body as a die, weight saving of the die can be attained.

In this embodiment, it is preferable to constitute such that the oxidation resistant film 12 of the die main body (surface-coated cermet material 1) is exfoliated by 90% or more when an extruded product is extruded by 10 m from the initiation of the extrusion. That is, if the exfoliated amount of the oxidation resistant film after the extrusion is too small, there is a risk that it becomes difficult to sufficiently exert the excellent performance of the TiCN series sintered body.

The oxidation resistant film exfoliated from the die main body (surface-coated cermet material) will be included in the extrusion material.

In addition, for the embodiment, the surface-coated cermet material related to the present invention was explained by exemplifying a case in which it is used for an extrusion die, but the surface-coated cermet material of the present invention is not limited to those, and can be used for other materials, such as drawing die such as tube expansion and shrinking die, warm, hot and cold forging mold, die cast mold, bending mold, warm, hot and cold plating roll, plastic forming mold such as forging mold, and cutting tools such as torch tips and bite.

### EXAMPLES

Next, the specific examples of the present invention will be explained, but the present invention is not limited to these examples.

In addition, in the explanation of the following embodiment, the amount of components of the processing solution contained is shown in parts by mass, but the parts by mass is relative to 100 parts by mass to the total amount of the processing solution by mass, and the value is essentially the same as mass %.

### Example 1

In the same manner as in the aforementioned embodiment, a cermet base material constituted by titanium carbonitride series sintered body was prepared. As a processing solution for forming an oxidation resistant film, a compound in which 9.3 mass parts of acetic acid Ni (II) 4-hydrate, 4.7 mass parts of polyvinylpyrrolidone (paste), 1.9 mass parts of alkyl glucoside (surfactant), 5.6 mass parts of glycerine (polyalcohol), 4.9 mass parts of citric acid, 6.5 mass parts of sodium hydrogen carbonate (sodium), and 67.1 mass parts of water were mixed was also prepared.

After applying the processing solution to a surface of the cermet base material, it was dried and heated up to 500° C. in a circulating hot air oven in the atmosphere (in air), maintained at 500° C. for 30 minutes to form an oxidation resistant film constituted by ilmenite-type complex oxide (NiTiO₃ layer) on the cermet base material to thereby obtain a surface-coated cermet material. In this case, the oxidation resistant film formed on the surface showed blue interference color.

The surface-coated cermet member obtained in this way was tested for changes in thermogravimetry under the following conditions, based on the TGA (thermogravimetric analysis, thermogravimetric measurement).

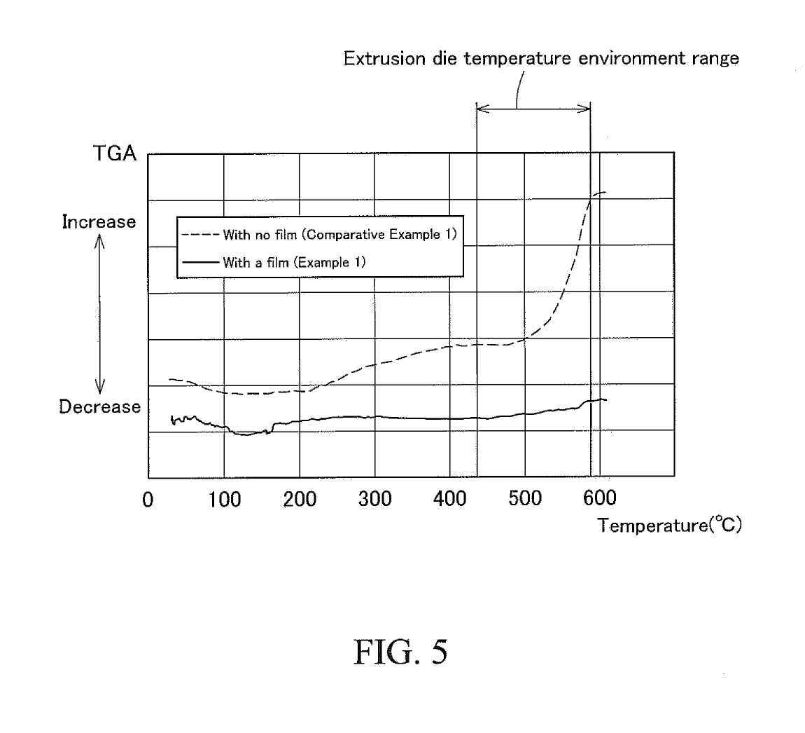

At this time, a testing apparatus with a product name of “DTG60H” manufactured by Shimadzu Corporation was used as a testing apparatus. Furthermore, a test sample of the surface-coated cermet member in this Example 1 was 3 mm×4 mm×0.15 mm. This sample was disposed in a cell of alumina and set in the testing equipment. The change in thermogravimetry was measured in the atmosphere (in air) while setting the temperature raising rate to 1° C./min. The measured results are shown in FIG. 5.

### Comparative Example 1

A cermet base material made of the same titanium carbonitride sintered body as in the aforementioned Example 1 in which no oxidation resistant film was formed was used as a sample of a Comparative Example and subjected to a similar test. The test results are also shown in FIG. 5.

### <Evaluation of Oxidation Resistance>

As will be apparent from FIG. 5, in Example 1 having an oxidation resistant film, there was almost no change in thermogravimetry (weight increase) even if the heating temperature rose, which revealed that oxidation barely progressed.

On the other hand, in Comparative Example having no oxidation resistant film, as the heating temperature rose, the weight increased, which revealed that oxidation progressed. Especially in Comparative Example, the weight increased rapidly within the extrusion die temperature environment range, which revealed that oxidation progressed rapidly within this temperature environment range.

As explained above, in the Example 1, even if the material was exposed to oxygen atmosphere under high temperatures, oxidation of the cermet base material can be assuredly prevented. Therefore, it is considered to effectively prevent inconveniences due to oxidation, such as, e.g., damages and/or exfoliation due to surface deterioration.

### Example 2

In the same manner as in Example 1, a cermet base material constituted by titanium carbonitride series sintered body was prepared.

A mixture in which 9.8 mass parts of calcium acetate monohydrate, 3.9 mass parts of polyvinylpyrrolidone (paste), 1.4 mass parts of alkyl glucoside (surfactant), 4.4 mass parts of glycerine (polyalcohol), 24.4 mass parts of acetic acid, 4.9 mass parts of sodium acetate (sodium salt), and 51.2 mass parts of water were mixed was prepared as a processing liquid. This processing liquid was applied to the surface of the cermet base material and raised in temperature in air by a circulating hot air oven (electric furnace) to 500° C. and then held at 500° C. for 30 minutes. Thus, an oxidation resistant film constituted by complex oxide (CaTiO₃ layer) was formed on the cermet base material to thereby obtain a surface-coated cermet material. In this case, the oxidation resistant film presented glossy silver gray color.

The test sample made of the surface-coated cermet material according to this Example 2 was subjected to the same test as mentioned above. As a result, the same evaluation was obtained. In other words, also in Example 2, it was confirmed that there was no sudden weight increase up to the temperature range of 600° C. and the material was excellent in oxidation resistance.

### Example 3

As the processing solution, a compound in which 14.7 mass parts of acetic acid Co (II) 4-hydrate, 6.2 mass parts of polyvinylpyrrolidone (paste), 1.8 mass parts of alkyl glucoside (surfactant), 2.1 mass parts of glycerine (polyalcohol), and 75.2 mass parts of water were mixed was prepared. The processing solution was applied to a surface of the cermet base material, dried and heated up to 600° C. in air by a circulating hot air oven (electric furnace), maintained at 600° C. for 30 minutes to form a spinel-type complex oxide (Co₂TiO₄ layer) on the cermet base material to thereby obtain a surface-coated cermet material of Example 3. In this case, it was observed that an oxidation resistant film showed a bluish glossy color though not clear.

The test sample constituted by the surface-coated cermet material of Example 3 was subjected to the same test as mentioned above. As a result, the same evaluation was obtained. In other words, also in Example 3, it was confirmed that there was no sudden weight increase up to the temperature range of 600° C. and the material was excellent in oxidation resistance.

In order to evaluate the oxidation resistance of the surface-coated cermet material of Examples 1 to 3 and Comparative Example 1 obtained as mentioned above in actual use, the die main body 31 of the extrusion die 3 shown in FIG. 4 was constituted by each surface-coated cermet material 1, and an aluminum alloy round bar was extruded using this extrusion die 3.

The production of the extrusion die 3 was performed as follows. That is, a cermet base material 11 as a die main body 31 was thermally fitted to a heated die holder 32 of steel and then the oxidation resistant film was formed on the cermet base material 11 to thereby constitute the die main body 31 by the surface-coated cermet material 1 to produce an extrusion die 3. The heating temperature at the time of forming the oxidation resistant film was set to 500° C. and the heating time was set to 30 minutes. Thus, an oxidation resistant film 12 having a film thickness of 0.2 μm was formed.

Next, in performing the extrusion using the extrusion die 3, the extrusion die 3 was preheated at 450° C. for 300 minutes in a preheating furnace. Thereafter, the extrusion die 3 was set to a container of an extruder and an aluminum alloy round bar was extruded at a billet temperature of 450° C. The wear volume of the surface-coated cermet material 1 as a die main body 31 at the time when the extrusion length has reached 50,000 m was evaluated. The evaluation results of the wear volume are shown in Table 1.

TABLE 1

| | Cermet base | Oxidation | Wear volume |
|---|---|---|---|
| | material | resistant film | (μm) |
| Example 1 | TiCN series | Ilmenite-type | 4 |
| | sintered body | complex oxide | |
| | | (NiTiO₃) | |
| Example 2 | TiCN series | Perovskite-type | 4 |
| | sintered body | complex oxide | |
| | | (CaTiO₃) | |
| Example 3 | TiCN series | Spinel-type | 5 |
| | sintered body | complex oxide | |
| | | (Co₂TiO₄) | |
| Comparative | TiCN series | Nil | Larger than |
| Example 1 | sintered body | | 30 μm |
| Comparative | WC—Co super | Nil | 7 |
| Example 2 | hard | | |

As will be apparent from Table 1, in the extruded product produced using the extrusion die constituted by the surface-coated cermet material of Examples 1 to 3 of the present invention, the wear volume of the surface-coated cermet material was little and sufficient durability for a die was obtained.

On the other hand, in the extruded product produced using the extrusion die constituted by the cermet material of Comparative Example 1 with no oxidation resistant film (surface coating), the 50,000 m extrusion evaluation could not be performed. That is, at the time when the extrusion length has reached 10,000 m, the wear volume of the cermet material has reached 30 μm, and it was confirmed that the surface of the die after 10,000 m extrusion was dropped due to oxidation. In this Comparative Example 1, the wear was extremely quick as compared to conventional WC—Co super hard material of Comparative Example 2.

This application claims priority to Japanese Patent Application No. 2010-22043 filed on Feb. 3, 2010, and the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### INDUSTRIAL APPLICABILITY

The processing solution of the present invention can be used for forming an oxidation resistant film. Also, the surface-coated cermet material produced by the production method of the present invention can be used for a metal working product, such as, e.g., a cutting tool or an extrusion die.

### DESCRIPTION OF THE REFERENCE NUMERALS

1: surface-coated cermet material
11: cermet base material
12: oxidation resistant film

1. A processing solution for forming an oxidation resistant film on a surface-coated cermet material, wherein
the processing solution contains a metal salt which creates a complex oxide by reacting with a titanium compound, and 20 mass % or more of a solvent.

2. The processing solution for forming an oxidation resistant film on a surface-coated cermet material as recited in claim 1, wherein the processing solution is used for forming an oxidation resistant film containing a complex oxide by applying the processing solution onto a cermet base material and heating it to react with a titanium compound on a surface of the cermet base material.

3. The processing solution for forming an oxidation resistant film on a surface-coated cermet material as recited in claim 2, wherein the cermet base material is constituted by a sintered body including at least one or more titanium compounds selected from the group consisting of titanium carbide, titanium nitride, and titanium carbonitride as a main component of a hard phase.

4. The processing solution for forming an oxidation resistant film on a surface-coated cermet material as recited in claim 1, wherein the metal salt is a compound of transition metal of divalent iron ion.

5. The processing solution for forming an oxidation resistant film on a surface-coated cermet material as recited in claim 4, wherein the transition metal is Fe, Ni, Co, Mn, Mg, or Zn.

6. The processing solution for forming an oxidation resistant film on a surface-coated cermet material as recited in claim 4, wherein the compound of transition metal is nickel acetate.

7. The processing solution for forming an oxidation resistant film on a surface-coated cermet material as recited in claim 1, wherein the metal salt is an alkaline-earth metal compound.

8. The processing solution for forming an oxidation resistant film on a surface-coated cermet material as recited in claim 7, wherein the alkaline-earth metal is Ca, Sr, or Ba.

9. The processing solution for forming an oxidation resistant film on a surface-coated cermet material as recited in claim 7, wherein the alkaline-earth metal compound is calcium acetate.

10. The processing solution for forming an oxidation resistant film on a surface-coated cermet material as recited in claim 1, wherein the metal salt is magnesium salt or cobalt salt.

11. The processing solution for forming an oxidation resistant film on a surface-coated cermet material as recited in claim 1, wherein the metal salt is cobalt acetate.

12. The processing solution for forming an oxidation resistant film on a surface-coated cermet material as recited in claim 1, wherein the processing solution further contains a surfactant.

13. The processing solution for forming an oxidation resistant film on a surface-coated cermet material as recited in claim 1, wherein the solution contains water and a water soluble thickener.

14. The processing solution for forming an oxidation resistant film on a surface-coated cermet material as recited in claim 1, wherein the solution contains water and a water-soluble polyalcohol.

15. The processing solution for forming an oxidation resistant film on a surface-coated cermet material as recited in claim 1, wherein the solution further contains an organic acid.

16. The processing solution for forming an oxidation resistant film on a surface-coated cermet material as recited in claim 1, wherein the solution further contains a sodium salt.

17. A method of producing a surface-coated cermet material, comprising:
a process of applying a processing solution as recited in claim 1 on a surface of a cermet base material constituted by a sintered body including at least one or more titanium compounds selected from the group consisting of titanium carbide, titanium nitride, and titanium carbonitride as a main component of a hard phase; and
a process of forming an oxidation resistant film by heating the processing solution applied surface-coated cermet material after applying the processing solution.

18. A method of producing a surface-coated cermet material, comprising:
a process of oxidizing a cermet base material constituted by a sintered body including at least one or more titanium compounds selected from the group consisting of titanium carbide, titanium nitride, and titanium carbonitride as a main component of a hard phase;
a process of applying a processing solution as recited in claim 1 on a surface of the oxidized cermet base material; and
a process of forming an oxidation resistant film by heating the processing solution applied surface-coated cermet material after applying the processing solution.
